(19) United States
(12) Patent Application Publication
(10) Pub. No.: US 2021/0383266 A1
(43) Pub. Date: Dec. 9, 2021

(54) INFORMATION PROCESSING SYSTEM, METHOD FOR PROCESSING INFORMATION AND PROGRAM

(71) Applicants: KABUSHIKI KAISHA TOSHIBA, Tokyo (JP); TOSHIBA DIGITAL SOLUTIONS CORPORATION, Kawasaki-shi (JP)

(72) Inventor: Kotaro ENDO, Shinjuku Tokyo (JP)

(73) Assignees: KABUSHIKI KAISHA TOSHIBA, Tokyo (JP); TOSHIBA DIGITAL SOLUTIONS CORPORATION, Kawasaki-shi (JP)

(21) Appl. No.: 17/445,591

(22) Filed: Aug. 20, 2021

Related U.S. Application Data
(63) Continuation of application No. PCT/JP2019/006708, filed on Feb. 22, 2019.

(51) Int. Cl. G06N 7/08; G06K 9/62

(52) U.S. Cl. CPC G06N 7/08; G06K 9/6296; G06K 9/6228

(57) ABSTRACT

An information processing system as an embodiment of the present invention includes: a first computer that generates an edge group that is a group of edges connected to corresponding nodes for each of the nodes in a graph of a Hamiltonian path problem, a binary variable indicating whether the edges included in the edge group are selected as a path for each of edge groups, and an Ising model with the binary variable as a spin; and a second computer that calculates a solution of the Ising model. The first computer acquires a solution of the Hamiltonian path problem based on the solution of the Ising model calculated by the second computer.

### CROSS REFERENCE TO RELATED APPLICATIONS

This application is continuation application of International Application No. JP2019/006708, filed on Feb. 22, 2019, the entire contents of which are incorporated herein by reference.

### FIELD

Embodiments of the present invention relate to an information processing system, a method for processing information, and a program.

### BACKGROUND ART

### Background

In recent years, a computer using a quantum annealing phenomenon and a computer that emulates a quantum annealing phenomenon have been developed. For example, Patent Literature 1 discloses a method for solving a quadratic optimization problem. These computers are expected to solve a combinational optimization problem at high speed. When the computers described above are each used, a problem may need to be converted into an Ising model in advance.

Unfortunately, when a graph of the Hamiltonian path problem is converted into the Ising model, the number of spins required for calculation excessively increases. When the method of Non Patent Literature 1 is used, the number of spins of the square of the number of nodes of the graph is required after conversion into the Ising model. This problem requires development of a technique for solving the Hamiltonian path problem at high speed while reducing necessary calculation resources.

### BRIEF DESCRIPTION OF DRAWINGS

FIG. 1 is a block diagram illustrating a configuration example of an information processing system according to a first embodiment.

FIG. 2 is a diagram illustrating an example of an undirected Hamiltonian cycle problem.

FIG. 3 is a flowchart illustrating an example of a conversion process into an Ising model.

FIG. 4 is a table illustrating an example of a group of edges.

FIG. 5 is a diagram illustrating an example of a pseudo solution.

FIG. 6 is a flowchart illustrating an example of a process of verifying a solution of an Ising machine.

FIG. 7 is a flowchart illustrating an example of a process of verifying a solution of an Ising machine.

FIG. 8 is a table illustrating an example of edges selected as a path.

FIG. 9 is a flowchart illustrating an example of the entire process executed by an information processing system.

FIG. 10 is a diagram illustrating an example of a directed Hamiltonian cycle problem.

FIG. 11 is a flowchart illustrating an example of a conversion process into an Ising model.

FIG. 12 is a table illustrating an example of a group of edges.

FIG. 13 is a flowchart illustrating an example of a process of verifying a solution of an Ising machine.

FIG. 14 is a flowchart illustrating an example of a process of verifying a solution of an Ising machine.

FIG. 15 is a table illustrating an example of edges selected as a path.

FIG. 16 is a block diagram illustrating a configuration example of an information processing system according to a third embodiment.

FIG. 17 is a block diagram illustrating a configuration example of an information processing system according to a fourth embodiment.

FIG. 18 is a block diagram illustrating a configuration example of a computer.

### DETAILED DESCRIPTION

An information processing system as an embodiment of the present invention includes: a first computer that generates an edge group that is a group of edges connected to corresponding nodes for each of the nodes in a graph of a Hamiltonian path problem, a binary variable indicating whether the edges included in the edge group are selected as a path for each of edge groups, and an Ising model with the binary variable as a spin; and a second computer that calculates a solution of the Ising model. The first computer acquires a solution of the Hamiltonian path problem based on the solution of the Ising model calculated by the second computer.

Hereinafter, embodiments of the present invention will be described with reference to the drawings. In the drawings, the same components are denoted by the same reference numerals, and duplicated description thereof will be eliminated as appropriate.

### First Embodiment

First, an outline of an information processing system according to a first embodiment will be described. The information processing system according to the first embodiment converts a Hamiltonian path problem into an Ising model to acquire a solution of the Hamiltonian path problem. The Hamiltonian path problem refers to a problem of acquiring a path that passes through all nodes only once for an arbitrary graph. In the Hamiltonian path problem, a start node and an end node of a path may be different from each other. Thus, the path of the Hamiltonian path problem is not necessarily a cycle. In contrast, for an arbitrary graph, a problem of acquiring a cycle passing through all nodes only once is referred to as a Hamiltonian cycle problem. It can be said that the Hamiltonian cycle problem is acquired by adding a condition that a start node and an end node are identical to each other to the Hamiltonian path problem. The Hamiltonian path problem and the Hamiltonian cycle problem apply to a graph that includes a plurality of nodes and an edge connecting two nodes (a pair of nodes). Every pair of nodes does not necessarily include an edge. In the Hamiltonian path problem and the Hamiltonian cycle problem, reducing the number of edges between nodes enables alleviating the problems and facilitating solving the problems.

In the first embodiment, solving the Hamiltonian cycle problem using the information processing system will be described as an example. However, this example does not hinder solving the Hamiltonian path problem, in which a path has a start node and an end node that are different from each other, using the information processing system. Solving the Hamiltonian path problem, in which a path has a start node and an end node that are different from each other, will be described later.

In an Ising model, a function of energy is expressed by a quadratic polynomial of multiple variables si (i=1, 2, . . . ) each having a binary value of any one of +1 and −1. Here, the function of energy is called Hamiltonian. The Hamiltonian corresponds to an objective function in a combinatorial optimization problem. The variables si are each also referred to as a binary variable or spin. The Ising model has an optimum solution that is a combination of values (vector) of the variables causing minimum energy. The Ising model has a parameter that is a binary variable, and thus facilitates conversion into a discrete variable used in the combinational optimization problem. For example, the binary numbers 0 and 1 each can be associated with any one of +1 and −1. Details of the Ising model will be described later.

To solve a Hamiltonian cycle problem by associating each variable si with a combination of a node v of a graph and an order w on a path, N² variables si are required. As the Hamiltonian cycle problem increases in scale, the number of nodes vmax increases. Thus, when such formulation is performed, the number of variables si necessary for solving the problem greatly increases.

Increase in the number of spins required to solve the Hamiltonian cycle problem may cause an Ising machine with the number of spins capable of handling a real problem to be unable to be prepared, or cost of the Ising machine to be very high. Here, the Ising machine refers to a computer that solves the Ising model. For example, a quantum annealing machine using a superconducting quantum bit or a gate-type quantum computer may have an upper limit on the number of spins that can be handled, due to hardware constraints. When a von Neumann computer is used, the number of necessary computers increases. In general, as the number of spins required to solve the problem increases, time required for calculation also increases.

Thus, to solve an actual Hamiltonian cycle problem at high speed, the number of spins required to be used in a computer is preferably reduced. The information processing system according to the present embodiment is configured to convert a graph of the Hamiltonian cycle problem into the Ising model to cause the number of required spins to be equal to the number of edges of the graph. Then, the Ising model is solved by the Ising machine. The solution needs to satisfy a predetermined condition. The Ising machine repeats a solving process until a solution satisfying the condition is obtained. Here, the predetermined condition may be that the solution is an optimum solution or may be other conditions. The predetermined condition may be a combination of the former and the latter.

When the number of nodes indicated as N, the number of edges of the graph has an upper limit of N(N−1)/2. Thus, the number of required spins can be reduced to less than half as compared with when a combination of the node v of the graph and the order w on the path is associated with each variable si. It is known that searching for a Hamiltonian cycle in a graph having a large number of edges is relatively easy. In reality, the search for the Hamiltonian cycle in a graph with the number of edges smaller than N(N−1)/2 is often performed. For this reason, a problem that is actually handled causes the number of required spins to be smaller than N(N−1)/2.

The number of required spins is reduced, so that a problem larger in scale can be solved using the Ising machine. Reducing the number of spins also can shorten calculation time. That is, the information processing system according to the present embodiment is capable of solving the Hamiltonian path problem at high speed while reducing necessary calculation resources.

Hereinafter, a configuration example of the information processing system according to the first embodiment will be described.

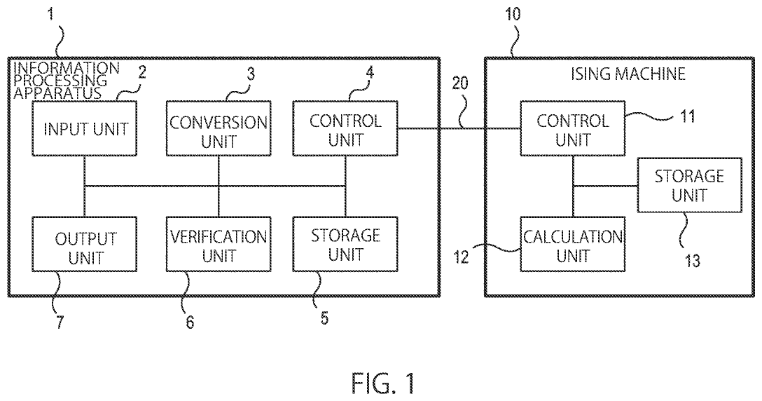

FIG. 1 is a diagram illustrating a configuration example of the information processing system according to the first embodiment. The system of FIG. 1 includes an information processing apparatus 1 and an Ising machine 10. The information processing apparatus 1 is a computer (first computer) including a processor and a storage device. Details of each component of the information processing apparatus 1 will be described later. The Ising machine 10 is a computer (second computer) that solves an Ising model. The information processing apparatus 1 and the Ising machine 10 are connected through a network 20. This enables data communication between the information processing apparatus 1 and the Ising machine 10. Although examples of the network 20 include a communication network based on TCP/IP, an interface and a communication standard to be used are not particularly limited in type.

The Ising machine 10 is not particularly limited in type. For example, the Ising machine 10 may be a quantum annealing machine. The Ising machine 10 may be also a quantum gate-type quantum computer. The Ising machine 10 may execute a program for solving an Ising model on a von Neumann computer. For example, a program for executing the Simulated Annealing method can be used.

The Ising machine 10 may be also a combination of a von Neumann computer and a hardware circuit that executes at least a part of the solving process of the Ising model. Although examples of the hardware circuit include an FPGA and an ASIC, the circuit is not limited in type. The Ising machine 10 may be fabricated using a plurality of von Neumann computers. Additionally, the Ising machine 10 may be a combination of the above-described computers, or may be a computer having another configuration.

The Ising model has been mainly used as a model of a ferromagnet or a phase transition phenomenon. However, in recent years, use as a model for solving a combination optimization problem has increased. Hereinafter, an outline of the Ising model will be described. Expression (1) below indicates a Hamiltonian H of the Ising model. The Hamiltonian H is energy of the Ising model. The Hamiltonian H also corresponds to an objective function in the optimization problem.

$$[ Expression 1 ]$$

$$H = - {\sum }_{< i , j >} {J}_{ij} {s}_{i} {s}_{j} - {\sum }_{i = 1}^{N} {h}_{i} {s}_{i} \qquad ( 1 )$$

where Jᵢⱼ is a matrix of interaction coefficients between spins, sᵢ and sᵢ are binary variables (spins) and each have a value of +1 or −1, and hᵢ is a vector of a local magnetic field at each spin.

The Ising machine 10 includes a calculation unit 12 that acquires a solution of the Ising model. The calculation unit 12 acquires a vector (s₁, s₂, . . . , s_{N}) of a parameter in which the Hamiltonian H has a value as small as possible. The solution of the Ising model acquired by the calculation unit 12 is a vector (s₁, s₂, . . . , s_{N}) of the above-described parameter. The solution acquired by the calculation unit 12 is expected to be a solution (optimum solution) in which the Hamiltonian H has a minimum value. However, the solution acquired by the calculation unit 12 is not necessarily an optimum solution. For example, the optimum solution may be acquired by executing the solving process multiple times. Alternatively, the optimum solution may be acquired by performing the solving process in parallel using a plurality of calculation units 12.

The Ising machine 10 includes a control unit 11 that controls each component of the Ising machine 10. For example, the control unit 11 of the Ising machine 10 receives a control signal transmitted from a control unit 4 of the information processing apparatus 1 through the network 20. The control unit 11 of the Ising machine 10 controls the calculation unit 12 on the basis of the control signal. The control unit 11 of the Ising machine 10 also transfers the solution of the Ising model acquired by the calculation unit 12 to the information processing apparatus 1.

The Ising machine includes a storage unit 13 that provides a storage region capable of storing various data including data necessary for operation of the Ising machine. For example, the control unit 11 of the Ising machine 10 may use the storage unit 13 as a buffer in which the data on the Ising model or the solution of the Ising model is temporarily stored. The storage unit 13 may store also a program and control data.

The storage unit 13 may be, for example, a volatile memory such as an SRAM or a DRAM, or may be a nonvolatile memory such as an NAND, an MRAM, or an FRAM. The storage unit 13 may be also a storage device such as a hard disk or an SSD, or an external storage device. That is, the storage unit 13 is not particularly limited in type. Additionally, the storage unit 13 may be a combination of a plurality of types of memory and storage. The Ising machine 10 may not necessarily include the storage unit 13.

Next, each component of the information processing apparatus 1 will be described. The information processing apparatus 1 includes an input unit 2, a conversion unit 3, the control unit 4, a storage unit 5, a verification unit 6, and an output unit 7.

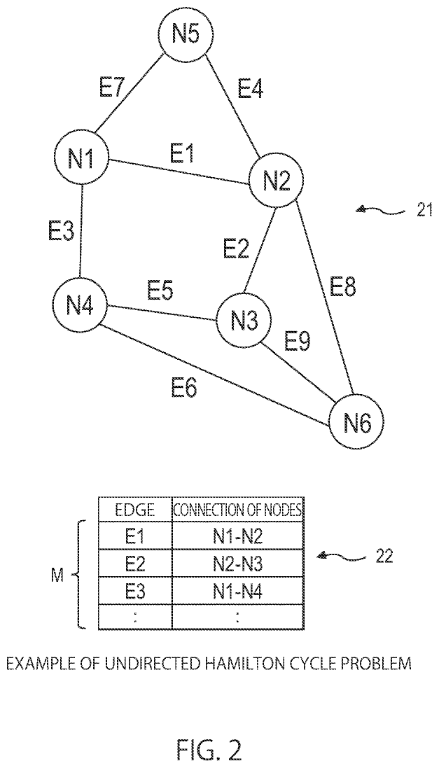

The Hamiltonian cycle problem is input to the information processing apparatus 1 using the input unit 2. A method for inputting the Hamiltonian cycle problem to the information processing apparatus 1 is not particularly limited. For example, the input unit 2 may be an input device such as a keyboard, a mouse, or a touch panel. In this case, a user can input the Hamiltonian cycle problem using the input device. The input unit 2 may be a communication circuit capable of performing data communication with another information processing apparatus. This case enables the communication circuit to download data on the Hamiltonian cycle problem from another information processing apparatus. The data on the Hamiltonian cycle problem input from the input unit 2 is stored in the storage unit 5. An example of the data on the Hamiltonian cycle problem will be described below with reference to FIG. 2.

FIG. 2 illustrates an example of an undirected Hamiltonian cycle problem. FIG. 2 illustrates a graph 21 that is an undirected graph. The graph 21 includes nodes N1 to N6 and edges E1 to E9. In the example of FIG. 2, the number of nodes N is six, and the number of edges M is nine. The values of N and M in FIG. 2 are examples, and thus the graph may have the numbers of nodes and edges that are different from those in FIG. 2. FIG. 2 illustrates a table 22 that stores a pair of nodes to which the corresponding one of the edges of the graph 21 is connected. The table 22 includes entries as many as the number of edges M. For example, an edge E1 connects a pair of a node N1 and a node N2. The table 22 also stores information on a pair of nodes to which another edge is connected.

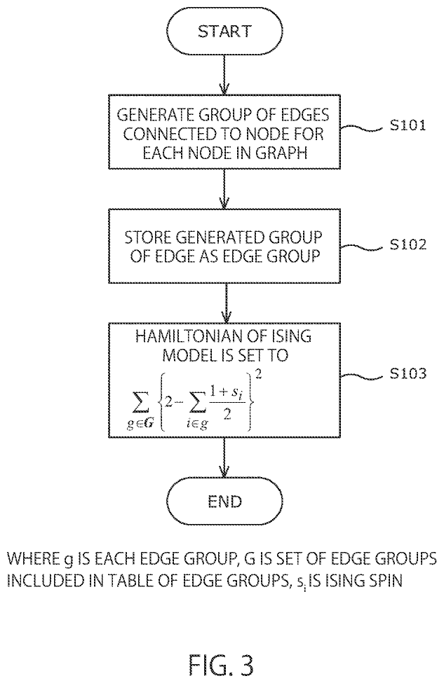

The conversion unit 3 converts the graph of the Hamiltonian cycle problem into an Ising model. FIG. 3 is a flowchart illustrating an example of a conversion process into the Ising model. Here, an example of the process executed by the conversion unit 3 will be described with reference to FIG. 3.

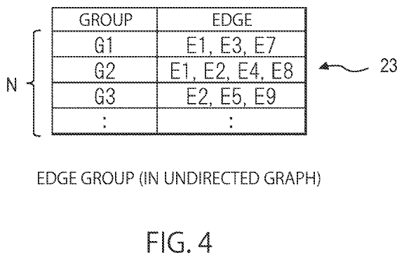

First, the conversion unit 3 generates a group of edges connected to corresponding one of nodes of the graph for each of the nodes (step S101). Then, the conversion unit 3 stores the generated group of edges in the storage unit 5 as an edge group (step S102). FIG. 4 illustrates a table 23 that is an example in which edge groups are generated for the graph of FIG. 2. The table 23 includes entries as many as nodes N. For example, a group G1 includes edges E1, E3, and E7 connected to the node N1. A group G2 includes edges E1, E2, E4, and E7 connected to the node N2. That is, it can be said that the edge groups are each a list of the edges connected to the corresponding one of the nodes of the graph.

Next, the conversion unit 3 sets an expression of the Hamiltonian (energy) of the Ising model to Expression (2) below (step S103).

$$[ Expression 2 ]$$

$$H = {\sum }_{g ∈ G} {\{ 2 - {\sum }_{i ∈ g} \frac{1 + {s}_{i}}{2} \}}^{2} \qquad ( 2 )$$

where g is each edge group, G is a set of edge groups included in the table of edge groups, and sᵢ is a spin (binary variable).

As described above, the information processing system according to the present embodiment is configured to associate each edge of the graph with the spin. When an edge is selected as a path, a spin si of +1 corresponds to the edge. In contrast, when an edge is not selected as a path, a spin si of −1 corresponds to the edge. When a path between corresponding nodes forms the Hamiltonian cycle, it can be said that an edge constituting the Hamiltonian cycle corresponds to the spin si of +1, and an edge not constituting the Hamiltonian cycle corresponds to the spin si of −1.

Referring to Expression (2), it is obvious that when there are two edges (two spins of +1) selected as a path in one edge group, a value of a term corresponding to the edge group becomes minimum (2−2/2−2/2=0). This corresponds to a state in which two edges among edges connected to a certain node are selected as a path in the graph. The term corresponding to the edge group has a value that does not depend on the number of edges (the number of spins of −1) not selected as a path in the edge group.

The condition that two edges are selected as a path among edges connected to corresponding one of nodes of the graph corresponds to a case where two spins among spins corresponding to edges included in each edge group are each +1 in Expression (2). At this time, Expression (2) includes energy H of 0 that is a minimum. That is, the correspondence relationship described above shows that when a solution output from the Ising machine has energy H of 0, the Hamiltonian cycle may be formed in which a path on edges connects corresponding nodes. The energy H of 0 is a necessary condition for the solution of the Ising machine to form the Hamiltonian cycle, but is not a sufficient condition. The reason for this will be described later.

The conversion unit 3 may store data on the Ising model generated in the conversion process in the storage unit 5. The conversion unit 3 may also transfer the data on the Ising model generated in the conversion process to the control unit 4.

The control unit 4 controls the Ising machine 10 to acquire a solution of the Ising model. For example, the control unit 4 transfers the data on the Ising model to the Ising machine 10. Then, the control unit 4 transmits a command for calculating a solution of the Ising model to the Ising machine 10. That is, the control unit 4 is capable of transmitting various control signals to the Ising machine 10 through the network 20. The control unit 4 also receives a calculated solution of the Ising model from the Ising machine 10. The control unit 4 may cause the storage unit 5 to store the received solution of the Ising model. The control unit 4 may also transfer the received solution of the Ising model to the verification unit 6.

The storage unit 5 provides a storage area capable of storing various data such as data related to a graph of a Hamiltonian cycle problem, data necessary for conversion of the graph into an Ising model, data necessary for verification of a solution of the Ising model, and data on a program operating in the information processing apparatus 1. The storage unit 5 may be, for example, a volatile memory such as an SRAM or a DRAM, or may be a nonvolatile memory such as an NAND, an MRAM, or an FRAM. The storage unit 13 may be also a storage device such as a hard disk or an SSD, or an external storage device. That is, the storage unit 5 is not particularly limited in type. Additionally, the storage unit 5 may be a combination of a plurality of types of memory and storage.

The verification unit 6 verifies whether the solution calculated by the Ising machine 10 is a solution to the Hamiltonian cycle problem. For example, depending on the specification and type of the Ising machine 10, the solution may not always have calculated energy H of 0. When the energy H is not 0, a path corresponding to the calculated solution does not form a Hamiltonian cycle on a graph. Thus, the verification unit 6 determines that the solution calculated by the Ising machine 10 is not the solution to the Hamiltonian cycle problem.

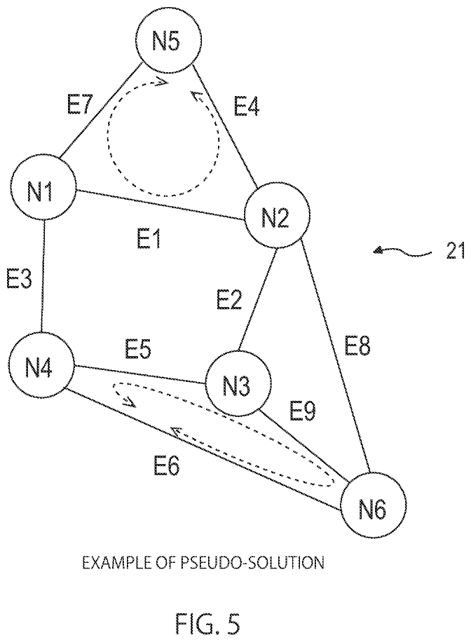

However, even when an optimum solution of the Ising problem is obtained in which the solution has the energy H of 0, a path corresponding to the solution does not necessarily form the Hamiltonian cycle on the graph. For example, the path corresponding to the calculated solution forms a cycle including edges E1, E4, and E7, and a cycle including edges E5, E9, and E6, in the graph 21 of FIG. 2. In this case, two edges among edges connected to corresponding nodes are selected as a path for all the nodes of the graph 21, so that Expression (2) includes the energy H of 0. However, such a path does not satisfy the condition of the Hamiltonian cycle. Thus, when the path corresponding to the solution calculated by the Ising machine 10 forms a plurality of cycles on the graph, the verification unit 6 determines that the solution is not the solution of the Hamiltonian cycle problem. A solution that forms a plurality of cycles on a graph is referred to as a pseudo-solution. FIG. 5 illustrates an example of the pseudo-solution.

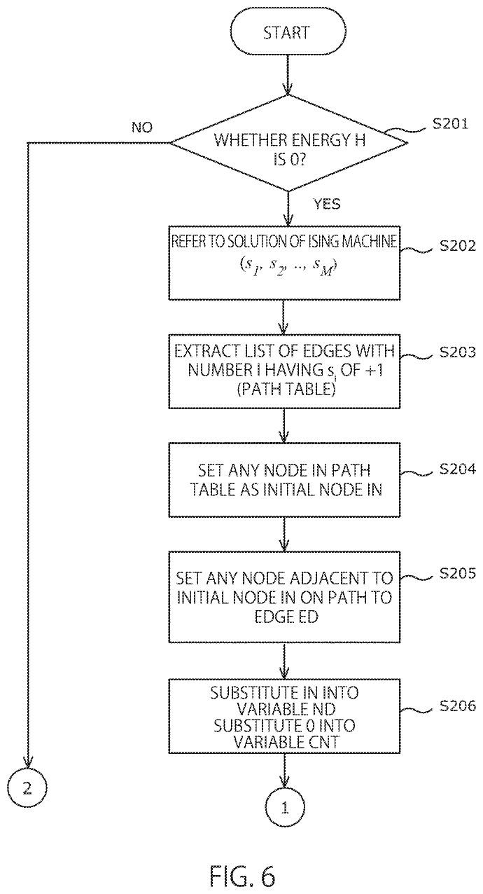

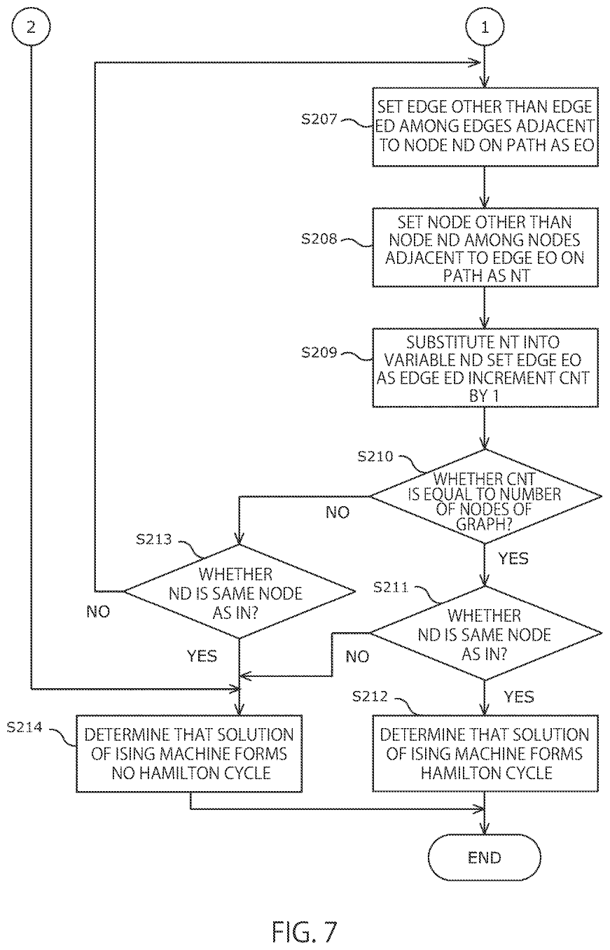

FIGS. 6 and 7 are each a flowchart illustrating an example of a process of verifying a solution of the Ising machine. Hereinafter, the process will be described with reference to FIGS. 6 and 7.

First, the verification unit 6 determines whether the solution calculated by the Ising machine 10 has the energy H of 0 (step S201). When the solution has the energy H other than 0 (NO in step S201), the verification unit 6 determines that the solution of the Ising machine does not form the Hamiltonian cycle on the graph (step S214).

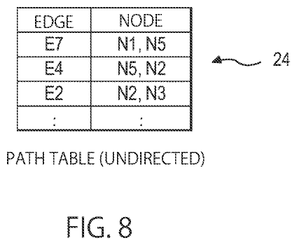

When the solution has the energy H of 0 (YES in step S201), the verification unit 6 refers to the solution of the Ising machine (s₁, s₂, . . . , s_{M}) (step S202). Then, the verification unit 6 extracts a list of edges each with a number i that satisfies si of +1 from the solution of the Ising machine (step S203). Step S203 corresponds to a process of extracting an edge selected as a path. FIG. 8 illustrates a table 24 that shows an example of the list of edges extracted in step S203. The table 24 has a first column indicating an edge selected as a path. Then, a second column indicates a pair of nodes to which the edge is connected. Hereinafter, the table generated in step S203 is referred to as a path table. The table 24 is an example of the path table.

Next, the verification unit 6 sets any node in the path table as an initial node IN (step S204). Then, the verification unit 6 sets any edge adjacent to the initial node IN on the path as an edge ED (step S205). For example, in the table 24, when a node N5 is selected as the initial node IN, the edge E4 or E7 is set as the edge ED.

Next, the verification unit 6 substitutes IN to a variable ND and substitutes 0 to a variable CNT (step S206). Then, the verification unit 6 sets an edge other than the edge ED among edges adjacent to the node ND on the path as an edge EO (step S207). Next, the verification unit 6 sets a node other than the node ND among nodes adjacent to the edge EO on the path as a node NT (step S208).

Then, the verification unit 6 substitutes NT into the variable ND. The verification unit 6 also sets the edge EO as the edge ED. Additionally, the verification unit 6 increments a value of the variable CNT by 1. Step S209 is described above. Next, the verification unit 6 determines whether the variable CNT has a value equal to the number of nodes of the graph (step S210). In the determination in step S210, the verification unit 6 checks whether all the nodes of the graph have been traced.

When the variable CNT has a value different from the number of nodes of the graph (NO in step S210), the verification unit 6 checks whether the variable ND indicates a node identical to the initial node IN (step S213). When the variable ND indicates a node other than the initial node IN (NO in step S213), the verification unit 6 repeats the processes in steps S207 to S209 and then performs the determination in step S210 again. When the variable ND indicates the node identical to the initial node IN (YES in step S213), the verification unit 6 determines that the solution of the Ising machine does not form the Hamiltonian cycle (step S214).

When the variable CNT has a value equal to the number of nodes of the graph (YES in step S210), the verification unit 6 checks whether the variable ND indicates a node identical to the initial node IN (step S211). When the variable ND indicates the node identical to the initial node IN (YES in step S211), the verification unit 6 determines that the solution of the Ising machine forms the Hamiltonian cycle (step S212). When the variable ND indicates a node other than the initial node IN (NO in step S211), the verification unit 6 determines that the solution of the Ising machine does not form the Hamiltonian cycle (step S214).

When it is determined whether the solution of the Ising machine forms the Hamiltonian cycle (step S212 or step S214), the processes of FIGS. 6 and 7 ends. The verification unit 6 may cause the storage unit 5 to store information indicating whether the solution of the Ising machine forms the Hamiltonian cycle. The verification unit 6 may also notify the user of a result of a verifying process. The processes illustrated in FIGS. 6 and 7 are each merely an example of the verifying process of the solution of the Ising machine. Thus, it may be determined whether the solution of the Ising machine forms the Hamiltonian cycle by a process different from the example.

The output unit 7 outputs an acquired solution to the Hamiltonian cycle problem. A format of data output by the output unit 7 is not particularly limited. For example, the output unit 7 may cause a display to display the solution to the Hamiltonian cycle problem. The output unit 7 may also print the solution to the Hamiltonian cycle problem on paper using a printer. The output unit 7 may cause an external storage device to store data on the solution to the Hamiltonian cycle problem. The output unit 7 may transmit the data on the solution to the Hamiltonian cycle problem to an external information processing apparatus using a communication circuit.

The input unit 2, the conversion unit 3, the control unit 4, the verification unit 6, the output unit 7, and the control unit 11 of the Ising machine 10 of the information processing apparatus 1 may be implemented by, for example, a processor such as a CPU, or a hardware circuit such as an ASIC, an FPGA, or a CPLD. Each of the above-described components may be implemented by a program such as an operating system (OS) or an application, or a combination of hardware and a program. The calculation unit 12 of the Ising machine 10 is not particularly limited in configuration. For example, the calculation unit 12 may be implemented by various hardware circuits or may be implemented by various programs. As described above, the configuration of the calculation unit 12 of the Ising machine 10 differs depending on a type of the Ising machine.

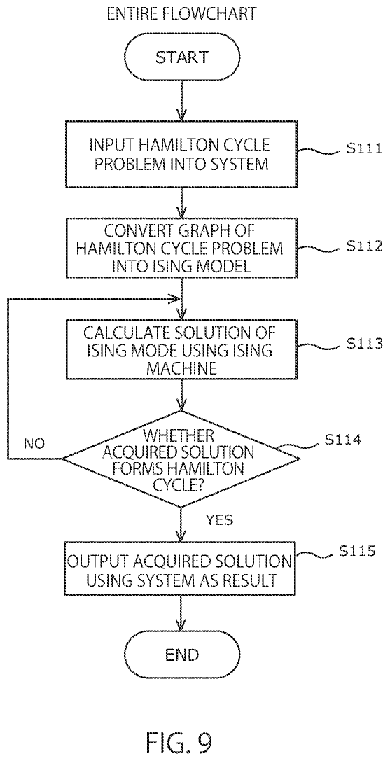

FIG. 9 is a flowchart illustrating an example of the entire process executed by an information processing system. Hereinafter, the process will be described with reference to FIG. 9.

First, the Hamiltonian cycle problem is input to the system using the input unit 2 of the information processing apparatus 1 (step S111). As described in the description of the input unit 2, a method for inputting the Hamiltonian cycle problem into the system is not particularly limited. Then, the conversion unit 3 of the information processing apparatus 1 converts the Hamiltonian cycle problem into the Ising model (step S112). Details of the conversion process executed in step S112 are as described in the description of the conversion unit and FIGS. 3 and 4. The control unit 4 of the information processing apparatus 1 transfers data on the Ising model to the Ising machine 10, and transmits a start command of the solving process to the Ising machine 10. Then, a solution of the Ising model is calculated using the Ising machine 10 (step S113).

When the solution of the Ising model is acquired by the Ising machine 10, the solution of the Ising model is transferred to the information processing apparatus 1. The verification unit 6 of the information processing apparatus 1 verifies whether the solution of the Ising model forms the Hamiltonian cycle (step S114). Details of the verifying process executed in step S114 are as described in the description of the verification unit 6 and FIGS. 5 to 8.

When the verification unit 6 of the information processing apparatus 1 determines that the solution of the Ising model does not form the Hamiltonian cycle (NO in step S114), the control unit 4 of the information processing apparatus 1 transmits the start command of the solving process to the Ising machine 10 again. Then, the Ising machine 10 calculates a solution of the Ising model again (step S113).

Even when the same Ising model is used, a different solution is expected to be output from the Ising machine 10 through trial. Output of a different solution through trial is caused by a factor that varies depending on a type of the Ising machine 10. For example, a quantum annealing machine or a gate-type quantum computer is configured to observe any one of superposition states in a quantum bit with a quantum theoretical probability, and thus a different solution is output through trial. In contrast, a von Neumann computer or a computer using a hardware circuit may output a different solution through trial due to effect of pseudorandom numbers used during the solving process.

Thus, probability of acquiring a solution forming the Hamiltonian cycle through multiple trials (solving process using the Ising machine 10) increases. An Ising machine capable of high speed processing may be used to increase the number of trials performed per unit time. Although in the flowchart of FIG. 9, an upper limit is not particularly set for the number of trials, an upper limit may be set for the number of trials. For example, when a solution for forming the Hamiltonian cycle cannot be obtained through repeated trials within a predetermined time, a process may be stopped. When the number of trials is counted and a counted value exceeds a threshold value, the process may be stopped.

When the verification unit 6 of the information processing apparatus 1 determines that a solution of the Ising model forms the Hamiltonian cycle (YES in step S114), the system outputs the obtained solution as a result (step S115). Details of the process executed in step S115 are as described in the description of the output unit 7.

The information processing system according to the first embodiment reduces the number of spins required for calculation. Thus, the Hamiltonian path problem can be solved at high speed while necessary calculation resources are reduced.

### Second Embodiment

In the first embodiment, an example of acquiring a solution to the Hamiltonian cycle problem of an undirected graph has been described. However, a solution to the Hamiltonian cycle problem in a directed graph may be acquired using an information processing system according to the present embodiment. The second embodiment shows a solving process in which a solution to the Hamiltonian cycle problem of a directed graph is acquired. Except for a difference in a process to be executed, the information processing system according to the second embodiment has a configuration similar to that in the first embodiment (the configuration in FIG. 1). Hereinafter, the information processing system according to the second embodiment will be described focusing on differences from the first embodiment.

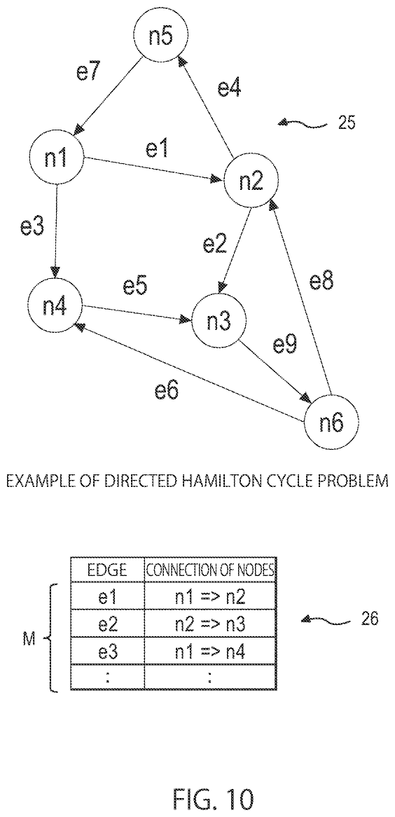

A directed Hamiltonian cycle problem is input to an information processing apparatus 1 using an input unit 2. FIG. 10 illustrates an example of the directed Hamiltonian cycle problem. FIG. 10 illustrates a graph 25 that is a directed graph. The graph 25 includes nodes n1 to n6 and edges e1 to e9. The example of FIG. 10 shows that the number of nodes N is 6, and the number of edges M is 9. Values of N and M in FIG. 10 are examples. The graph may have the numbers of nodes and edges that are different from those in FIG. 10. The table 26 of FIG. 10 includes entries as many as the number of edges M. For example, an edge e1 is directed from a node n1 to a node n2.

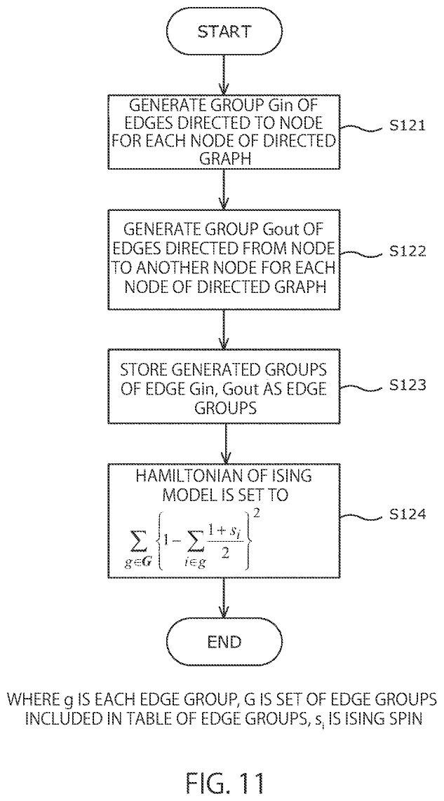

A conversion unit 3 converts the directed graph of the Hamiltonian cycle problem into an Ising model. FIG. 11 is a flowchart illustrating an example of a conversion process into the Ising model. Here, an example of the process executed by the conversion unit 3 will be described with reference to FIG. 11.

First, the conversion unit 3 generates a group Gin of edges directed to corresponding one of nodes of the directed graph for each of the nodes (step S121). The conversion unit 3 also generates a group Gout of edges directed from corresponding one of nodes to another node of the directed graph for each of the nodes (step S122). Then, the conversion unit 3 stores the generated groups of edges in the storage unit 5 as edge groups (step S123).

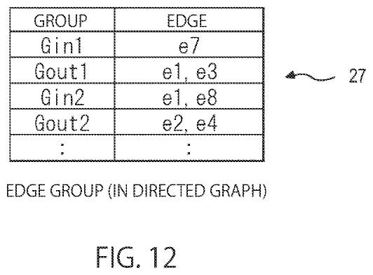

FIG. 12 illustrates a table 27 that is an example in which edge groups are generated for the graph of FIG. 10. The table 27 includes entries as many as 2N that is twice the number of nodes. For example, a group Gin1 includes an edge e7 directed to the node n1. A group Gout1 includes edges e1 and e3 directed from the node n1 to other nodes. As described above, an edge group is a list of edges that are connected to the corresponding nodes of the graph. However, a group of edges directed to a certain node and a group of edges directed from a certain node to another node are different edge groups.

Next, the conversion unit 3 sets an expression of the Hamiltonian (energy) of the Ising model to Expression (3) below (step S124).

$$[ Expression 3 ]$$

$$H = {\sum }_{g ∈ G} {\{ 1 - {\sum }_{i ∈ g} \frac{1 + {s}_{i}}{2} \}}^{2} \qquad ( 3 )$$

where g is each edge group, G is a set of edge groups included in the table of edge groups, and sᵢ is a spin (binary variable).

Even in the second embodiment, each edge of the graph is associated with a spin. When an edge is selected as a path, a spin si of +1 corresponds to the edge. In contrast, when an edge is not selected as a path, a spin si of −1 corresponds to the edge.

Referring to Expression (3), it is obvious that when there is one edge (one spin of +1) selected as a path in each edge group, a value of a term corresponding to the edge group becomes minimum (1−2/2=0). This corresponds to a state in which an edge directed to one node and an edge directed from the one node to another node are selected as paths among edges connected to corresponding nodes in the graph. The term corresponding to the edge group has a value that does not depend on the number of edges (the number of spins of −1) not selected as a path in the edge group.

Thus, when spins corresponding to edges included in each edge group in Expression (2) includes one spin of +1, it can be said, for all nodes of the graph, that an edge directed to one node and an edge directed from the one node to other nodes are selected as paths among the edges connected to the corresponding nodes.

When spins corresponding to edges included in each edge group includes one spin of +1, Expression (3) includes energy H of 0 that is a minimum. That is, the correspondence relationship described above shows that when a solution output from the Ising machine has energy H of 0, the Hamiltonian cycle may be formed in which a path on edges connects corresponding nodes. As in the first embodiment, the energy H of 0 is a necessary condition for the solution of the Ising machine to form the Hamiltonian cycle, but is not a sufficient condition.

The verification unit 6 verifies whether the solution calculated by the Ising machine 10 is a solution to the Hamiltonian cycle problem. Hereinafter, the verifying process in the Hamiltonian cycle problem of the directed graph will be described.

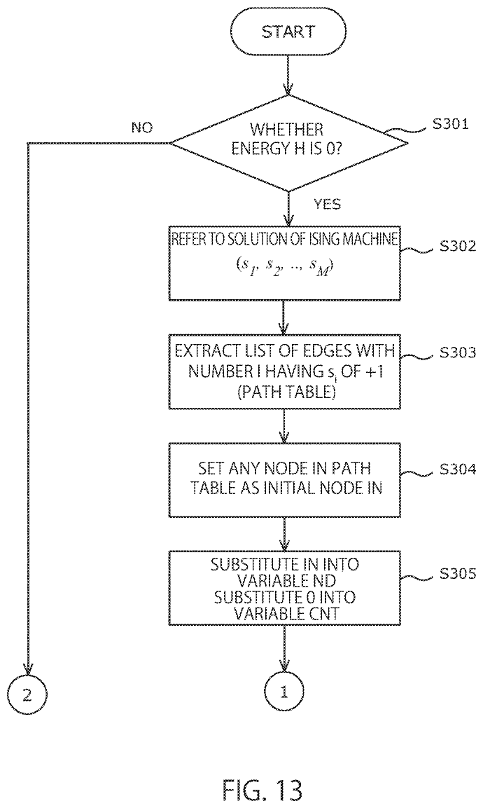

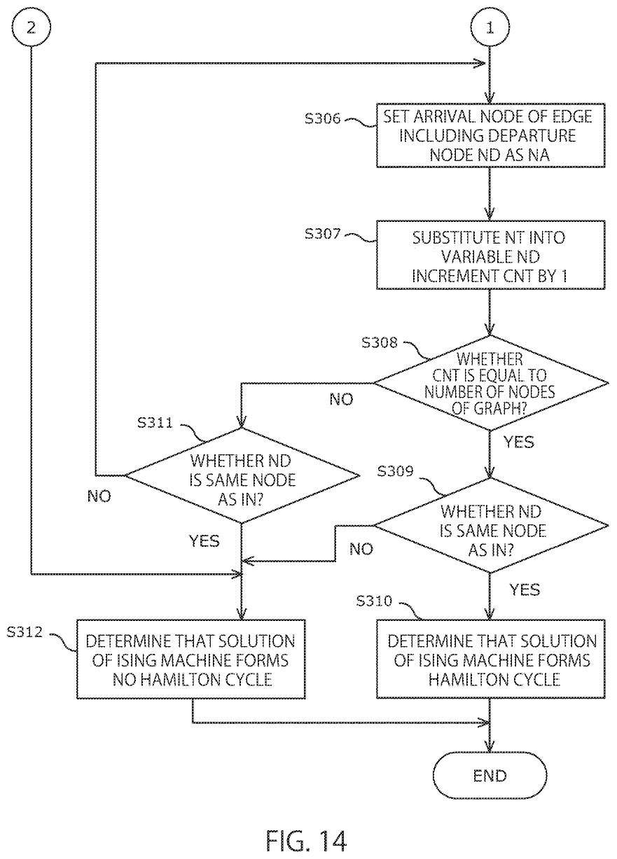

FIGS. 13 and 14 are each a flowchart illustrating an example of a process of verifying a solution of the Ising machine. Hereinafter, the process will be described with reference to FIGS. 13 and 14.

First, the verification unit 6 determines whether the solution calculated by the Ising machine 10 has the energy H of 0 (step S301). When the solution has the energy H other than 0 (NO in step S301), the verification unit 6 determines that the solution of the Ising machine does not form the Hamiltonian cycle on the graph (step S312).

When the solution has the energy H of 0 (YES in step S301), the verification unit 6 refers to the solution of the Ising machine (s₁, s₂, . . . , s_{M}) (step S302). Then, the verification unit 6 extracts a list of edges each with a number i that satisfies si of +1 from the solution of the Ising machine (step S303). Step S303 corresponds to a process of extracting an edge selected as a path.

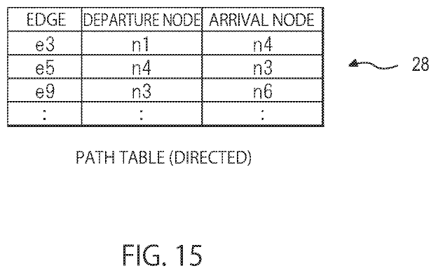

FIG. 15 illustrates a table 28 that shows an example of the list of edges extracted in step S303. The table 28 has a first column indicating an edge selected as a path. Then, a second column indicates a departure node, and a third column indicates an arrival node. Each row of the table 28 indicates an edge directed from the departure node to the arrival node. Hereinafter, the table generated in step S303 is referred to as a path table. The table 28 is an example of the path table.

Next, the verification unit 6 sets any node in the path table as an initial node IN (step S304). Then, the verification unit 6 substitutes IN to a variable ND and substitutes 0 to a variable CNT (step S305). Next, the verification unit 6 sets an arrival node of an edge having a departure node ND as NA (step S306).

Then, the verification unit 6 substitutes NA into the variable ND. Additionally, the verification unit 6 increments a value of the variable CNT by 1. Step S307 is described above. Next, the verification unit 6 determines whether the variable CNT has a value equal to the number of nodes of the graph (step S308). In the determination in step S308, the verification unit 6 checks whether all the nodes of the graph have been traced.

When the variable CNT has a value different from the number of nodes of the graph (NO in step S308), the verification unit 6 checks whether the variable ND indicates a node identical to the initial node IN (step S311). When the variable ND indicates a node other than the initial node IN (NO in step S311), the verification unit 6 repeats the processes in steps S306 and S307 and then performs the determination in step S308 again. When the variable ND indicates the node identical to the initial node IN (YES in step S311), the verification unit 6 determines that the solution of the Ising machine does not form the Hamiltonian cycle (step S312).

When the variable CNT has a value equal to the number of nodes of the graph (YES in step S308), the verification unit 6 checks whether the variable ND indicates a node identical to the initial node IN (step S309). When the variable ND indicates the node identical to the initial node IN (YES in step S309), the verification unit 6 determines that the solution of the Ising machine forms the Hamiltonian cycle (step S310). When the variable ND indicates a node other than the initial node IN (NO in step S309), the verification unit 6 determines that the solution of the Ising machine does not form the Hamiltonian cycle (step S312).

When it is determined whether the solution of the Ising machine forms the Hamiltonian cycle (step S310 or step S312), the processes of FIGS. 13 and 14 ends. The verification unit 6 may cause the storage unit 5 to store information indicating whether the solution of the Ising machine forms the Hamiltonian cycle. The verification unit 6 may also notify the user of a result of a verifying process. The processes illustrated in FIGS. 13 and 14 are each merely an example of the verifying process of the solution of the Ising machine. Thus, it may be determined whether the solution of the Ising machine forms the Hamiltonian cycle by a process different from the example.

The entire process of the information processing system according to the second embodiment is similar to that of the information processing system (the process in FIG. 9) according to the first embodiment. Even the information processing system according to the second embodiment reduces the number of spins required for calculation. Thus, the Hamiltonian path problem can be solved at high speed while necessary calculation resources are reduced.

### Third Embodiment

The information processing system according to the first embodiment includes one Ising machine. However, the information processing system may include a plurality of Ising machines. An information processing system according to a third embodiment includes a plurality of Ising machines. The plurality of Ising machines can execute solving processes in parallel. Hereinafter, the information processing system according to the third embodiment will be described focusing on differences from the first and second embodiments.

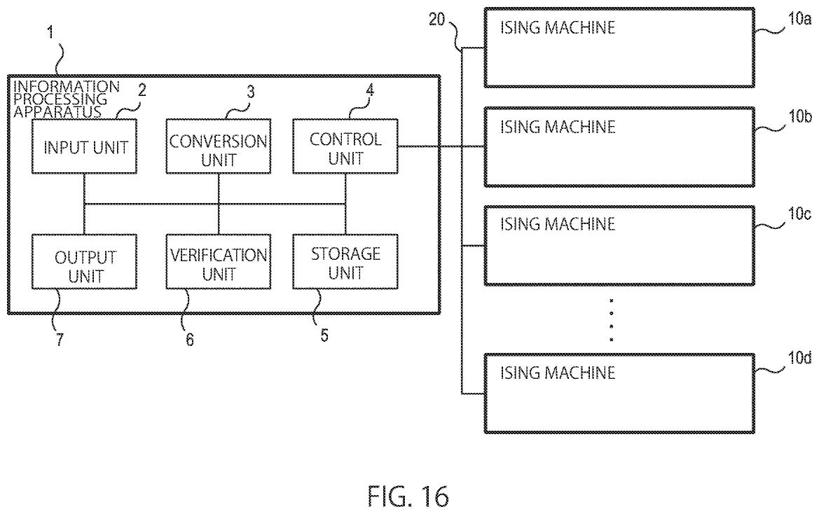

FIG. 16 is a block diagram illustrating a configuration example of the information processing system according to the third embodiment. The information processing system of FIG. 16 includes an information processing apparatus 1, an Ising machine 10a, an Ising machine 10b, an Ising machine 10c, and an Ising machine 10d. Although FIG. 16 illustrates the four Ising machines, this is only an example. Thus, the number of Ising machines may be different from this. For example, a thousand Ising machines may be used.

The information processing apparatus 1 and the ising machines 10a to 10d are connected through a network 20. This enables data communication between the information processing apparatus 1 and the Ising machines 10a to 10d. Although examples of the network 20 include a communication network based on TCP/IP, an interface and a communication standard to be used are not particularly limited in type.

Internal components of the Ising machines 10a to 10d are eliminated in FIG. 16. However, the Ising machines 10a to 10d each have a configuration similar to that of the Ising machine 10 in FIG. 1. The Ising machines 10a to 10d are not particularly limited in type. For example, the Ising machines 10a to 10d may be the same type of Ising machine. The Ising machines 10a to 10d may also include a plurality of types of Ising machine. Each type of Ising machine has different characteristics, so that probability of acquiring an optimum solution and calculation time may differ depending on an Ising model. Thus, using a plurality of types of Ising machine enables increasing the probability of acquiring an optimum solution, and reducing the calculation time.

For example, a control unit 4 transmits a command for acquiring calculation of a solution of the same Ising model to the Ising machines 10a to 10d. Then, the Ising machines 10a to 10d each calculate a solution of the same Ising model in parallel. Depending on a type of Ising machine, improvement in performance by parallel calculation may be expected. Then, the control unit 4 of the information processing apparatus 1 receives a calculated solution of the Ising model from each of the Ising machines 10a to 10d. The information processing apparatus 1 includes a verification unit 6 that determines whether the solution calculated by each Ising machine forms a solution of a Hamiltonian cycle. The verification unit 6 may execute a verifying process of a plurality of solutions in parallel. The verification unit 6 may also sequentially execute the verifying process of each solution. When the verification unit 6 determines that any of the solutions forms the solution of the Hamiltonian cycle, an output unit 7 outputs the solution of the Hamiltonian cycle in various formats.

A graph of the Hamiltonian cycle problem to be input to an input unit 2 may be a directed graph or an undirected graph. Thus, a conversion unit 3 may convert the directed graph into an Ising model or may convert the undirected graph into an Ising model. Details of a conversion process executed by the conversion unit 3 are as described in the first embodiment and the second embodiment.

### Fourth Embodiment

The information processing systems according to the first to third embodiments are each configured to calculate a solution of an Ising model (solving process) after the Hamiltonian cycle problem is converted (conversion process) into the Ising model. However, the conversion process for the Ising model may not be executed as long as a solution to the Hamiltonian cycle problem can be acquired. An information processing system according to a fourth embodiment is configured to solve the Hamiltonian cycle problem using a metaheuristics algorithm. While the metaheuristics algorithm is executed, a solution is converted such that when two or one edge belonging to an edge group is not selected as a path, a value of an objective function is reduced by inverting a value of a binary variable.

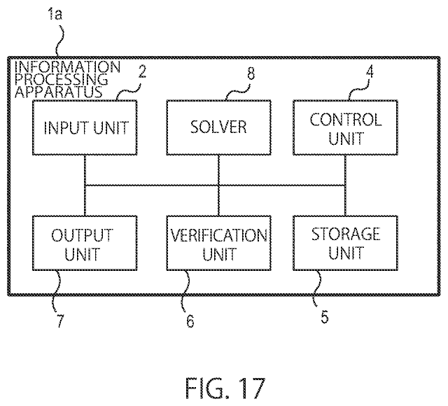

FIG. 17 is a block diagram illustrating a configuration example of the information processing system according to the fourth embodiment. FIG. 17 illustrates an information processing apparatus 1a that includes an input unit 2, a control unit 4, a storage unit 5, a verification unit 6, an output unit 7, and a solver 8. The input unit 2, the storage unit 5, the verification unit 6, and the output unit 7 have functions as in the information processing apparatuses according to the first to third embodiments. The control unit 4 controls each component of the information processing apparatus 1a.

The solver 8 solves the Hamiltonian cycle problem using the metaheuristics algorithm. The solver 8 receives information (information on a node and an edge connecting nodes) on a graph of the Hamiltonian cycle problem. Examples of the metaheuristics algorithm include a Simulated Annealing method, a local search method such as a tabu search, particle swarm optimization (PSO), a genetic algorithm, and the like. However, the solver 8 may use any kind of algorithm. For example, the Simulated Annealing method is configured such that an optimum solution or a local optimum solution close to the optimum solution is searched while conversion from an initial solution to a solution is repeated.

Examples of the solver 8 include a program for executing a metaheuristics algorithm on a processor. However, the solver 8 may be implemented by a hardware circuit such as an FPGA or an ASIC, and an implementation method is not particularly limited. The fourth embodiment includes the solver 8 that executes a process corresponding to the Ising machine according to each of the above-described embodiments.

Hereinafter, an example in which the solver 8 uses the Simulated Annealing method will be described. Here, a function of energy E having a variable sᵢ (i=1, 2, . . . , M) as a parameter is used as the objective function. Then, an acquired optimum solution is to be a minimum of the energy E. The variable sᵢ takes a value of +1 or −1.

The Hamiltonian cycle problem of an undirected graph can use Expression (4) below as a variation of the energy E when a value of a variable sj is inverted for conversion of a solution.

$$[ Expression 4 ]$$

$$\frac{\partial E}{\partial {s}_{j}} = - {\sum }_{g ∈ {G}_{j}} \{ 2 - {\sum }_{i ∈ g} \frac{1 + {s}_{i}}{2} \} \qquad ( 4 )$$

where Gⱼ is a set of edge groups including sⱼ, and a set g is each edge group included in Gⱼ.

The Hamiltonian cycle problem of a directed graph can use Expression (5) below as a variation of the energy E when a value of a variable sj is inverted for conversion of a solution.

$$[ Expression 5 ]$$

$$\frac{\partial E}{\partial {s}_{j}} = - {\sum }_{g ∈ {G}_{j}} \{ 1 - {\sum }_{i ∈ g} \frac{1 + {s}_{i}}{2} \} \qquad ( 5 )$$

where Gⱼ is a set of edge groups including sⱼ, and a set g is each edge group included in G.

In Expressions (4) and (5), which are each a conversion formula, when an edge is selected as a path, a variable si of +1 corresponds to the edge. In contrast, when an edge is not selected as a path, a variable si of −1 corresponds to the edge.

In Expression (4), when two edges belonging to an edge group are selected as a path, ∂E/∂sⱼ is 0, and thus a value of the energy E does not change when a solution is converted. However, when none of edges belonging to the edge group is selected as a path, and when only one edge belonging to the edge group is selected as a path, ∂E/∂sⱼ is less than 0, and thus the value of the energy E decreases due to inversion of a value of the binary variable sⱼ. The change in the energy E corresponds to update of a value of the objective function. The value of the objective function is updated, so that probability of inverting the value of the binary variable sⱼ for conversion of a solution increases.

In Expression (5), when one edge belonging to the edge group is selected as a path, ∂E/∂sⱼ is 0, and thus a value of the energy E does not change when a value of the binary variable sⱼ is inverted. However, when none of edges belonging to the edge group is selected as a path, ∂E/∂sⱼ is less than 0, and thus the value of the energy E decreases due to inversion of the value of the binary variable sⱼ. The change in the energy E corresponds to update of a value of the objective function. The value of the objective function is updated, so that probability of inverting the value of the binary variable sⱼ for conversion of a solution increases.

The fourth embodiment requires a calculation process of a variation of the energy E every time a solution is converted by the solver 8. However, the conversion process of converting a graph into an Ising model in the first to third embodiments becomes unnecessary. Thus, use of the information processing system according to the fourth embodiment may shorten calculation time as compared with the first to third embodiments.

### Fifth Embodiment

Each of the embodiments described above describes an example in which the information processing system solves the Hamiltonian cycle problem in which a path has a start node and an end node that are identical to each other. However, the start node and the end node of the path are not necessarily identical to each other. A fifth embodiment will describe a case of acquiring a solution to a Hamiltonian path problem in which a path has a start node and an end node that are different from each other. Hereinafter, an information processing system according to the fifth embodiment will be described focusing on differences from the first to third embodiments.

When a start node and an end node of a path on a graph are different from each other, Expression (6) below can be used as the Hamiltonian H.

$$[ Expression 6 ]$$

$$H = {\sum }_{g ∈ G} {\{ {T}_{g} - {\sum }_{i ∈ g} \frac{1 + {s}_{i}}{2} \}}^{2} \qquad ( 6 )$$

where g is each edge group, G is a set of edge groups included in the table of edge groups, and sᵢ is a spin (variable). Expression (6) shows T_{g} that takes a different value depending on conditions as described below.

In a Hamiltonian path problem of an undirected graph, when an edge group g is a group of edges connected to a start node or an end node, T_{g} is 1. When the edge group g is a group of edges connected to nodes other than those of the start point and the end point, T_{g} is 2. In a Hamiltonian path problem of a directed graph, when the edge group g includes an edge directed to a start node or an edge directed from an end node to another node, T_{g} is 0. When the edge group g does not include an edge directed to the start node and an edge directed from the end node to another node, T_{g} is 1.

When a path has a start node and an end node that are identical to each other in a Hamiltonian path problem of an undirected graph, T_{g} is 2 in Expression (6) regardless of an edge group g. This condition corresponds to Expression (2) described above. Similarly, when a path has a start node and an end node that are identical to each other in a Hamiltonian path problem of a directed graph, T_{g} is 1 in Expression (6) regardless of an edge group g. This condition corresponds to Expression (3) described above. Thus, Expression (6) described above can also be said to be a generalized expression of a Hamiltonian.

Except for a difference in a Hamiltonian used in a process, functions and configurations of the information processing system according to the fifth embodiment are similar to those of the information processing systems according to the first to third embodiments.

### Sixth Embodiment

The fourth embodiment describes the Hamiltonian cycle problem that is solved using the metaheuristics algorithm. A Hamiltonian path problem in which a path has a start node and an end node that are different from each other may be solved using a metaheuristics algorithm. Hereinafter, an information processing system according to a sixth embodiment will be described focusing on differences from the fourth embodiment.

The information processing system according to the sixth embodiment has a configuration similar to that of FIG. 17 described above. The solver 8 uses Expression below for conversion of a solution.

A Hamiltonian path problem of an undirected graph can use Expression (7) below as a variation of energy E when a value of a variable sⱼ is inverted for conversion of a solution.

$$[ Expression 7 ]$$

$$\frac{\partial E}{\partial {s}_{j}} = - {\sum }_{g ∈ {G}_{j}} \{ {T}_{g} - {\sum }_{i ∈ g} \frac{1 + {s}_{i}}{2} \} \qquad ( 7 )$$

where Gⱼ is a set of edge groups including sⱼ, and a set g is each edge group included in Gⱼ. The variable sᵢ takes a value of +1 or −1.

In contrast, a Hamiltonian cycle problem of a directed graph can use Expression (8) below as a variation of the energy E when a value of the variable sⱼ is inverted for conversion of a solution.

$$[ Expression 8 ]$$

$$\frac{\partial E}{\partial {s}_{j}} = - {\sum }_{g ∈ {G}_{j}} \{ {T}_{g} - {\sum }_{i ∈ g} \frac{1 + {s}_{i}}{2} \} \qquad ( 8 )$$

where Gⱼ is a set of edge groups including sⱼ, and a set g is each edge group included in G. The variable sᵢ takes a value of +1 or −1.

Expressions (7) and (8) each include T_{g} that is a coefficient depending on a condition of an edge group as described below.

In a Hamiltonian path problem of an undirected graph, when an edge group g is a group of edges connected to a start node or an end node, T_{g} is 1. When the edge group g is a group of edges connected to nodes other than those of the start point and the end point, T_{g} is 2. In a Hamiltonian path problem of a directed graph, when the edge group g includes an edge directed to a start node or an edge directed from an end node to another node, T_{g} is 0. When the edge group g does not include an edge directed to the start node and an edge directed from the end node to another node, T_{g} is 1.

Except for a different in a calculation process of a variation of the energy E executed for conversion of a solution, functions and configurations of the information processing system according to the sixth embodiment are similar to those of the fourth embodiment.

In each of the embodiments described above, a variable sᵢ of +1 corresponds to an edge selected as a path. However, a variable si of −1 may correspond to the edge selected as the path. In this case, a sign of the variable may be inverted when a variation of the Hamiltonian H or the energy E is calculated. In the solving process according to each of the embodiments described above, a minimum of the objective function is an optimum solution. However, a problem may be formulated to allow a maximum of the objective function to be an optimum solution.

When a Hamiltonian path problem has a constraint condition that a specific edge is selected as a path, 1 is subtracted from a value of Tg for an edge group including the edge at the time of calculation using Expressions (6) to (8). Then, deleting the edge from the edge group enables the problem to be converted into a problem without a constraint condition. When a specific edge is not selected as a path in the Hamiltonian path problem, the edge may be deleted from the graph.

The information processing system according to each of the embodiments described above can be used for various uses. For example, DNA sequence assembly may be performed using the information processing system according to each of the embodiments described above. The information processing system according to each of the embodiments described above may be used for generating a vehicle dispatch plan, a delivery plan, a work assignment plan, a software test plan, and a machine test plan. The information processing system according to each of the embodiments described above may be also used for path search and optimization of a financial portfolio. The uses described here are examples, and do not hinder a use different from the uses of the information processing system according to each of the embodiments described above.

### Seventh Embodiment

A seventh embodiment will describe an application example to DNA sequence assembly. An information processing system according to the seventh embodiment has a configuration similar to that of each of the embodiments described above.

In the DNA sequence assembly, DNA strands are cleaved into DNA fragments. The DNA strands can be cleaved, for example, by using a restriction enzyme. Then, the DNA fragments are detected and a base sequence is specified. Finally, the DNA fragments with the base sequences specified are connected to construct a sequence of original DNA strands.

Using an information processing system for solving a Hamiltonian path problem enables specifying a connection relationship between DNA fragments. At this time, each DNA fragment can be associated with a node of a graph, and the connection relationship between the DNA fragments can be associated with an edge of the graph. When a solution of a Hamiltonian path related to the graph is acquired on the basis of the method described in each of the embodiments described above, the connection relationship between the DNA fragments can be specified.

That is, to determine the sequence of the DNA strands, the information processing apparatus generates a graph of the Hamiltonian path problem by associating a node with the corresponding one of the DNA fragments acquired by cleaving the DNA strands, and an edge with the connection relationship between the corresponding DNA fragments. Then, an edge group may be generated on the basis of the generated graph. An Ising model also may be generated on the basis of the edge group.

Whether each DNA fragment is connected can be determined based on duplication of the base sequence in each DNA fragment. Thus, when it is determined that the DNA fragment is not connected to another DNA fragment as a result of analyzing the base sequence of the DNA fragment using the information processing apparatus, an edge corresponding to the DNA fragment may be excluded from the edge group. This enables reducing the number of spins required for calculation, so that the amount of use of a calculation resource and calculation time can be reduced.

For example, a case is assumed in which it is found that the node N2 and the node N3 are not connected by an edge E2 in the graph 21 of FIG. 2. In this case, the edge E2 is deleted from the group G2 and a group G3 of the table 23 (edge group) of FIG. 4. Even when the information processing system is applied to a use other than the DNA sequence assembly, an edge group may be generated by excluding an unnecessary edge.

### Eighth Embodiment

An eighth embodiment will describe a hardware configuration of a computer. Examples of the computer include a server, a client terminal, a microcomputer of an embedded device, a tablet, a smartphone, a feature phone, and a personal computer. However, functions of the computer may be implemented by a virtual machine (VM), a container, or the like.

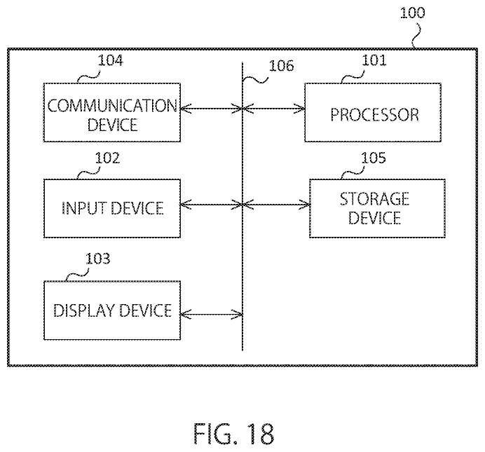

FIG. 18 is a diagram illustrating an example of a computer 100. The computer 100 of FIG. 18 includes a processor 101, an input device 102, a display device 103, a communication device 104, and a storage device 105. The processor 101, the input device 102, the display device 103, the communication device 104, and the storage device 105 are connected to each other using a bus 106.

The processor 101 is an electronic circuit including a control device and an arithmetic device of the computer 100. As the processor 101, for example, a general-purpose processor, a central processing unit (CPU), a microprocessor, a digital signal processor (DSP), a controller, a microcontroller, a state machine, an application-specific integrated circuit, a field programmable gate array (FPGA), a programmable logic circuit (PLD), or a combination thereof may be used.

The processor 101 performs arithmetic processing on the basis of data and a program received from each device (e.g., the input device 102, the communication device 104, and the storage device 105) connected using the bus 106, and outputs an arithmetic result and a control signal to each device (e.g., the display device 103, the communication device 104, and the storage device 105) connected using the bus 106. Specifically, the processor 101 executes an operating system (OS) of the computer 100, a program, and the like, and controls each device included in the computer 100.

Using the program enables functions of the information processing apparatus or the Ising machine according to each of the embodiments described above to be implemented in the computer 100. The program is stored in a storage medium that is non-transitory, tangible, and computer readable. The storage medium is, for example, an optical disk, a magneto-optical disk, a magnetic disk, a magnetic tape, a flash memory, or a semiconductor memory, but is not limited thereto. When the processor 101 executes the program, the computer 100 can provide the functions of the information processing apparatus or the Ising machine according to each of the above-described embodiments.

The input device 102 is used for inputting information to the computer 100. The input device 102 is, for example, a keyboard, a mouse, a touch panel, or the like, but is not limited thereto. A user can input a Hamiltonian path problem to the information processing system by using the input device 102.

The display device 103 is used for displaying an image and a video. The display device 103 is, for example, a liquid crystal display (LCD), a cathode ray tube (CRT), an organic electroluminescence (EL) display, a projector, an LED display, or the like, but is not limited thereto. The display device 103 displays an input screen of the Hamiltonian path problem, an execution result of calculation by the Ising machine, a verification result of a solution of the Ising machine, a display screen of a solution of the Hamiltonian path problem, and the like.

The communication device 104 is used for allowing the computer 100 to communicate with an external device in a wireless or wired manner. The communication device 104 is, for example, a network interface card (NIC), a communication module, a modem, a hub, a router, or the like, but is not limited thereto. The computer 100 may acquire data on the Hamiltonian path problem from a remote data center or information terminal using the communication device 104. When the computer 100 (information processing apparatus 1) is a server or the like installed in a data center or a machine room, the computer 100 may receive a command transmitted from a remote information communication terminal using the communication device 104, or may display contents of screen display on the remote information communication terminal.

The storage device 105 is a storage medium that stores an OS of the computer 100, a program, data necessary for executing the program, data generated by executing the program, and the like. The storage device 105 includes a main storage device and an external storage device. The main storage device is, for example, a RAM, a DRAM, or an SRAM, but is not limited thereto. The external storage device is, for example, a hard disk, an optical disk, a flash memory, a magnetic tape, or the like, but is not limited thereto. Data on the Hamiltonian path problem, an edge group, a path table, and a calculation result of the Ising machine may be stored in the storage device 105 or may be stored in an external server or storage.

The computer 100 may include one or more processors 101, one or more input devices 102, one or more display devices 103, one or more communication devices 104, and one or more storage devices 105. The computer 100 may be connected to a peripheral device such as a printer or a scanner.

The information processing apparatus and the Ising machine according to each of the embodiments described above may be composed of a single computer 100, or may be composed of an information system in which a plurality of computers 100 is connected to each other.

The program may be preliminarily stored in the storage device 105 of the computer 100, may be stored in a storage medium outside the computer 100, or may be uploaded onto the Internet. In any case, when the program is installed in the computer 100 and executed, the functions of the information processing apparatus or the Ising machine according to each of the embodiments described above can be implemented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing system comprising:
a first computer that generates an edge group that is a group of edges connected to corresponding nodes for each of the nodes in a graph of a Hamiltonian path problem, a binary variable indicating whether the edges included in the edge group are selected as a path for each of edge groups, and an Ising model with the binary variable as a spin; and
a second computer that calculates a solution of the Ising model,
the first computer acquiring a solution of the Hamiltonian path problem based on the solution of the Ising model calculated by the second computer.

2. The information processing system according to claim 1, wherein
when the solution of the Hamiltonian path problem is not acquired based on the solution of the Ising model calculated by the second computer, the first computer causes the second computer to calculate a solution of the Ising model again.

3. The information processing system according to claim 2, wherein the graph is an undirected graph, and
the solution of the Ising model calculated by the second computer corresponds to a case where two edges belonging to the edge group are selected as a path for all the edge groups.

4. The information processing system according to claim 2, wherein
the graph is a directed graph,
the first computer generates a group of the edges directed to the node and a group of the edges directed from the node to another node as separate edge groups, and
the solution of the Ising model calculated by the second computer corresponds to a case where one of the edges belonging to the edge group is selected as a path for all the edge groups.

5. The information processing system according to claim 1, wherein
the first computer generates the Ising model of Expression below using a set G of the edge groups, the edge group g, the binary variable sᵢ, and a coefficient T_{g} depending on conditions of the edge group g.
$$[ Expression 1 ]$$
$$H = {\sum }_{g ∈ G} {\{ {T}_{g} - {\sum }_{i ∈ g} \frac{1 + {s}_{i}}{2} \}}^{2} \qquad ( Expression )$$

6. The information processing system according to claim 5, wherein
when the node of a start point of the path and the node of an end point of the path are the same node and the graph is an undirected graph in the Hamiltonian path problem, the coefficient T_{g} has a value of 2 regardless of the edge group g.

7. The information processing system according to claim 5, wherein
when the node of a start point of the path and the node of an end point of the path are the same node and the graph is a directed graph in the Hamiltonian path problem, the coefficient T_{g} has a value of 1 regardless of the edge group g.

8. The information processing system according to claim 6, wherein
the first computer causes the second computer to execute calculation of a solution of the Ising model again when the solution of the Ising model calculated by the second computer forms a plurality of cycles on the graph.

9. The information processing system according to claim 5, wherein
when the graph is an undirected graph, the coefficient T_{g} has a value of 1 for the edge group g including the edges connected to the node of the start point or the node of the end point, and the coefficient T_{g} has a value of 2 for the edge group g including the edges connected to the nodes other than the start point and the end point.

10. The information processing system according to claim 5, wherein
when the graph is a directed graph, the coefficient Tg has a value of 0 for the edge group g including the edge directed to the node of the start point or the edge directed from the node of the end point to another node, and the coefficient Tg has a value of 1 for the edge group g not including the edge directed to the node of the start point and the edge directed from the node of the end point to another node.

11. The information processing system according to claim 1, wherein
the second computer is at least any one of a quantum annealing machine, a gate-type quantum computer, and a von Neumann computer capable of executing a Simulated Annealing method.

12. The information processing system according to claim 1, further comprising:
a plurality of the second computers.

13. The information processing system according to claim 1, wherein
the first computer generates the graph to determine a sequence of DNA strands by associating the node with corresponding one of DNA fragments acquired by cleaving the DNA strands and the edge with a connection relationship between the corresponding DNA fragments, and generates the edge group based on the generated graph.

14. The information processing system according to claim 13, wherein
the first computer excludes an edge corresponding to the DNA fragment from the edge group when it is determined that the DNA fragment is not connected to any of the DNA fragments.

15. The information processing system according to claim 1, wherein
the first computer generates the edge group by excluding at least one edge of the graph.

16. An information processing system comprising:
a hardware circuit that generates an edge group that is a group of edges connected to corresponding nodes for each of the nodes in a graph of a Hamiltonian path problem, and a binary variable indicating whether the edges included in the edge group are selected as a path for each of edge groups, and that calculates a solution of an objective function using the binary variable as a parameter to acquire a solution of the Hamiltonian path problem based on the solution of the objective function; and
a storage unit that stores the edge group generated by the hardware circuit and the binary variable generated by the hardware circuit.

17. The information processing system according to claim 16, wherein
when the graph is a directed graph, the hardware circuit generates a group of the edges directed to the node and a group of the edges directed from the node to another node as separate edge groups, and when one of the edges belonging to the edge group is not selected as a path, the hardware circuit updates a value of the objective function by inverting a value of the binary variable in calculation of a solution of the objective function.

18. The information processing system according to claim 16, wherein
when the graph is an undirected graph and two of the edges belonging to the edge group are not selected as a path, the hardware circuit updates a value of the objective function by inverting a value of the binary variable in calculation of a solution of the objective function.

19. A method for processing information that is executed by a computer, the method comprising the steps of:
generating an edge group that is a group of edges connected to corresponding nodes for each of the nodes in a graph of a Hamiltonian path problem;
generating a binary variable indicating whether the edges included in the edge group are selected as a path for each of edge groups;
generating an Ising model with the binary variable as a spin;
calculating a solution of the Ising model; and
acquiring a solution of the Hamiltonian path problem based on the solution of the Ising model.

20. A method for processing information that is executed by a computer, the method comprising the steps of:
generating an edge group that is a group of edges connected to corresponding nodes for each of the nodes in a graph of a Hamiltonian path problem;
generating a binary variable indicating whether the edges included in the edge group are selected as a path for each of edge groups;
calculating a solution of an objective function using the binary variable as a parameter; and
acquiring a solution of the Hamiltonian path problem based on the solution of the objective function.

21. A program causing a computer to execute the steps of:
generating an edge group that is a group of edges connected to corresponding nodes for each of the nodes in a graph of a Hamiltonian path problem;
generating a binary variable indicating whether the edges included in the edge group are selected as a path for each of edge groups;
generating an Ising model with the binary variable as a spin;
calculating a solution of the Ising model; and
acquiring a solution of the Hamiltonian path problem based on the solution of the Ising model.

22. The program according to claim 21, wherein
the solution of the Ising model is calculated by at least one of a quantum annealing machine, a gate-type quantum computer, and a von Neumann computer capable of executing a Simulated Annealing method.

23. A program causing a computer to execute the steps of:
generating an edge group that is a group of edges connected to corresponding nodes for each of the nodes in a graph of a Hamiltonian path problem;
generating a binary variable indicating whether the edges included in the edge group are selected as a path for each of edge groups;
calculating a solution of an objective function using the binary variable as a parameter; and
acquiring a solution of the Hamiltonian path problem based on the solution of the objective function.
